(19) United States
(12) Patent Application Publication
(10) Pub. No.: US 2011/0106701 A1
(43) Pub. Date: May 5, 2011

(54) METHOD AND APPARATUS FOR PERFORMING VOICE-BASED CREDIT CARD PROCESSING

(75) Inventors: Sridhar Jagannathan, Los Altos, CA (US); Matt Eric Hart, Lunenburg, MA (US)

(73) Assignee: INTUIT INC., Mountain View, CA (US)

(21) Appl. No.: 12/609,530

(22) Filed: Oct. 30, 2009

(51) Int. Cl. G06Q 20/00; H04M 1/66

(52) U.S. Cl. 705/44; 455/411; 455/466

(57) ABSTRACT

One embodiment of the present invention provides a system for performing voice-based credit card processing. During operation, the system receives voice input from a merchant at a computer via a telephone to initiate a credit card transaction. Next, the system authenticates the merchant. After authenticating the merchant, the system prompts the merchant for a credit card number. Next, the system authenticates a consumer associated with the credit card. Note that the system can authenticate the consumer with pre-registered information that is associated with the credit card. Once the consumer is authenticated, the system prompts the merchant for a transaction amount. Next, the system receives the transaction amount from the merchant. The system then authorizes the credit card transaction for the transaction amount. Finally, the system reports the result of the authorization to the merchant. Note that embodiments of the present invention enable the merchant to process credit card transactions at reduced cost without the need for any equipment other than a telephone, thus providing the ability to have instant credit card enabled merchants on demand.

### BACKGROUND

### Related Art

Credit card processing techniques have evolved over the years from the taking of card imprints, to processing transactions on POS machines with a dialup modem, to Internet-connected POS machines, and more recently to cellular-based POS solutions. While these techniques have evolved along with the underlying computing technology, they all require an expensive infrastructure.

For example, each one of these techniques require some form of specialized equipment, either to imprint the credit card or to read the magnetic strip on the credit card. Except for the credit card imprint technique, all of the other techniques require additional equipment to communicate that information to the credit card transaction processor.

In some circumstances, such as with small Mom and Pop businesses, the cost of these systems is prohibitive. Furthermore, in other situations, such as with fairs, exhibitions, and farmers' markets, the required infrastructure may simply be non-existent. In many situations, merchants typically resort to using manual card-imprint systems that have less security and higher transaction fees, or they simply do not accept credit card payments.

### SUMMARY

One embodiment of the present invention provides a system for performing voice-based credit card processing. During operation, the system receives voice input from a merchant at a computer via a telephone to initiate a credit card transaction. Next, the system authenticates the merchant. After authenticating the merchant, the system prompts the merchant for a credit card number. Next, the system authenticates a consumer associated with the credit card. Once the consumer is authenticated, the system prompts the merchant for a transaction amount. Next, the system receives the transaction amount from the merchant. The system then authorizes the credit card transaction for the transaction amount. Finally, the system reports the result of the authorization to the merchant.

In some embodiments of the present invention, the system authenticates the merchant by prompting the merchant for a merchant-authentication credential. Next, the system receives the merchant-authentication credential from the merchant. Finally, the system authenticates the merchant with the merchant-authentication credential.

In some embodiments of the present invention, the merchant-authentication credential can include at least one of: a numeric string comprising dual-tone multi-frequency (DTMF) sounds, a numeric string comprising spoken numerals, or a verbal string comprising spoken words.

In some embodiments of the present invention, the system authenticates the consumer by prompting the merchant for a consumer-authentication credential for the consumer associated with the credit card. Next, the system receives the consumer-authentication credential from the merchant. Finally, the system authenticates the consumer with the consumer-authentication credential.

In some embodiments of the present invention, the consumer-authentication credential includes at least one of: an expiration date of the credit card, a billing address of the credit card, a security code of the credit card, a driver's license number of the consumer, a Social Security number of the consumer, and a token pre-registered by the consumer.

In some embodiments of the present invention, authenticating the merchant additionally involves looking up a merchant password associated with the merchant-authentication credential. Next, the system prompts the merchant for the merchant password. The system then receives the merchant password from the merchant. Finally, the system determines if the merchant password received from the merchant matches the stored merchant password.

In some embodiments of the present invention, authenticating the merchant additionally involves determining a telephone number for a telephone originating the voice input. Next, the system retrieves a list of authorized telephone numbers associated with the merchant. Finally, the system determines if the telephone number is a member of the list of authorized telephone numbers.

In some embodiments of the present invention, authenticating the consumer additionally involves looking up a name associated with the credit card. Next, the system presents the name to the merchant. Finally, the system receives confirmation from the merchant that the name is correct.

In some embodiments of the present invention, authorizing the credit card transaction involves sending a Short Message Service (SMS) message to the consumer. The system then receives an SMS response from the consumer.

In some embodiments of the present invention, authorizing the credit card transaction involves placing an automated phone call to the consumer. Next, the system prompts the consumer to authorize the transaction. Finally, the system receives an acknowledgement from the consumer.

### BRIEF DESCRIPTION OF THE FIGURES

FIG. 1 illustrates a computing environment in accordance with an embodiment of the present invention.

FIG. 2 illustrates a system in accordance with an embodiment of the present invention.

FIG. 3 presents a flow chart illustrating the process of performing a voice-based credit card transaction in accordance with an embodiment of the present invention.

FIG. 4 presents a process flow diagram illustrating a voice-based authorization system for phone-based payments in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

Embodiments of the present invention provide secure voice-based credit card transaction processing system that operates via a telephone. In these embodiments, a merchant does not need to possess expensive processing or point-of-sale infrastructure. As long as the merchant has an active telephone line (land-based or cellular), the merchant will be able to use embodiments of the present invention to securely and inexpensively process credit card transactions.

Note that the described embodiments of the present invention are different from other phone-based credit card transaction processing systems because the processing is completely automated and provides additional security measures over existing systems. In most existing systems, the merchant provides information to an operator who then inputs the information into a traditional credit card processing system.

During normal operation, the system receives voice input from a merchant at a computer via a telephone to initiate a credit card transaction. Next, the system authenticates the merchant. After authenticating the merchant, the system prompts the merchant for a credit card number. Next, the system authenticates a consumer associated with the credit card. Once the consumer is authenticated, the system prompts the merchant for a transaction amount. Next, the system receives the transaction amount from the merchant. The system then authorizes the credit card transaction for the transaction amount. Finally, the system reports the result of the authorization to the merchant.

Note that, while the embodiments here are presented as an ordered list of steps, they are presented as such for exemplary purposes. In practice, these steps may be combined, completed in a different order, or completed concurrently. For example, the system may prompt the merchant for the credit card number and the transaction amount prior to authenticating the consumer.

In some embodiments of the present invention, the system authenticates the merchant by prompting the merchant for a merchant-authentication credential. Next, the system receives the merchant-authentication credential from the merchant. Finally, the system authenticates the merchant with the merchant-authentication credential.

Note that the merchant-authentication credential can include a merchant ID, a password, a list of pre-determined phone numbers that the merchant can call from, or any other information that can positively identify the merchant. Furthermore, the merchant-authentication credential may actually be two or more identifiers such as an ID and a password. Also note that in some embodiments the merchant-authentication credential may also identify a particular individual associated with the merchant. For example, the merchant-authentication credential may include an employee ID.

In some embodiments of the present invention, the merchant-authentication credential can include at least one of: a numeric string comprising dual-tone multi-frequency (DTMF) sounds, a numeric string comprising spoken numerals, or a verbal string comprising spoken words. Any method of input that can be recognized by a computer system may be used in embodiments of the present invention.

In some embodiments of the present invention, the system authenticates the consumer by prompting the merchant for a consumer-authentication credential for the consumer associated with the credit card. Next, the system receives the consumer-authentication credential from the merchant. Finally, the system authenticates the consumer with the consumer-authentication credential. Note that, as with the merchant-authentication credential, the consumer-authentication credential can comprise multiple credentials.

In some embodiments of the present invention, the consumer-authentication credential includes at least one of: an expiration date of the credit card, a billing address of the credit card, a security code of the credit card, a driver's license number of the consumer, a Social Security number of the consumer, and a token pre-registered by the consumer. Note that the token pre-registered by the consumer may include voiceprint signatures or other voice recognition and matching data.

Note that these consumer-authentication credentials can be provided to the system by the merchant, or by the consumer themselves. Additionally, these consumer-authentication credentials can be provided to the system over the same communication channel that the merchant has initiated, or over a different communication channel.

In some embodiments of the present invention, authenticating the merchant additionally involves looking up a merchant password associated with the merchant-authentication credential. Next, the system prompts the merchant for the merchant password. The system then receives the merchant password from the merchant. Finally, the system determines if the merchant password received from the merchant matches the stored merchant password. Note that the merchant may have one password, or may have multiple passwords wherein each employee of the merchant has his or her own password.

In some embodiments of the present invention, authenticating the merchant additionally involves determining an origin telephone number for a telephone originating the voice input. Next, the system retrieves a list of authorized telephone numbers associated with the merchant. Finally, the system determines if the origin telephone number is a member of the list of authorized telephone numbers. Note that while the use of calling number identification (CNID) techniques may help to authenticate the merchant, CNID systems can easily be tricked into reporting “spoofed” numbers.

In some embodiments of the present invention, authenticating the consumer additionally involves looking up a name associated with the credit card. Next, the system presents the name to the merchant. Finally, the system receives confirmation from the merchant that the name is correct.

It is important to note that many credit card transaction processors will not reveal information, such as the cardholder's name, to the merchant. Instead, these processors will typically only verify if the information supplied by the merchant is correct. In some embodiments, the merchant or the credit card transaction processor can request the consumer to pre-register information for this service, or to set permissions on what information can be shared.

In some embodiments of the present invention, authorizing the credit card transaction involves sending a Short Message Service (SMS) message to the consumer. The system then receives an SMS response from the consumer.

For example, once the merchant has been authenticated and has supplied the consumer's credit card number to the system, the system could send the consumer a text message to his or her cell phone with the details of the transaction and a request for the consumer to authorize the transaction. The consumer would then send a text message back to the system either confirming or denying the transaction.

In some embodiments of the present invention, authorizing the credit card transaction involves placing an automated phone call to the consumer. Next, the system prompts the consumer to authorize the transaction. Finally, the system receives an acknowledgement from the consumer.

For example, as with the SMS messages, the system can place an automated call to the mobile phone of the consumer. The consumer can then authorize or deny the transaction by voice, or by pressing a number on their keypad that corresponds to the desired action.

### Computing Environment

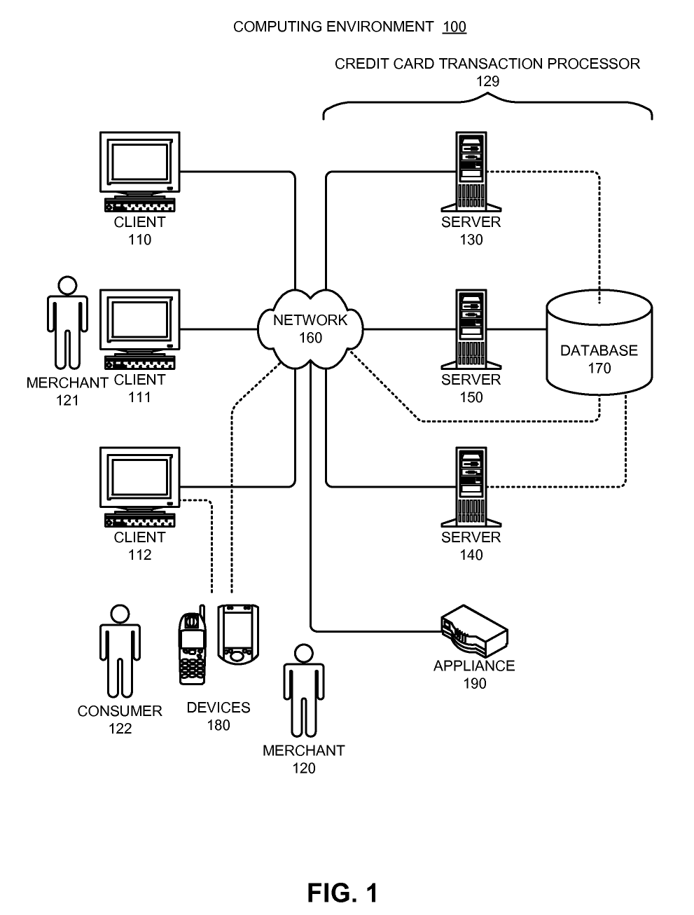

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, merchants 120 and 121, consumer 122, servers 130-150, network 160, database 170, devices 180, appliance 190, and credit card transaction processor 129.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Merchants 120 and 121 and consumer 122 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Credit card transaction processor 129 can include any combination of servers 130-150, network 160, database 170, and appliance 190. For example, in some embodiments of the present invention, credit card transaction processor 129 is comprised of server 150, while in another example, credit card transaction processor 129 is distributed across servers 130-150, database 170, and appliance 190. Furthermore, note that credit card transaction processor 129 is coupled to a telephone system.

Note that different embodiments of the present invention may use different system configurations, and are not limited to the system configuration illustrated in computing environment 100. In general, any device that is capable of communicating via network 160 may incorporate elements of the present invention.

### System

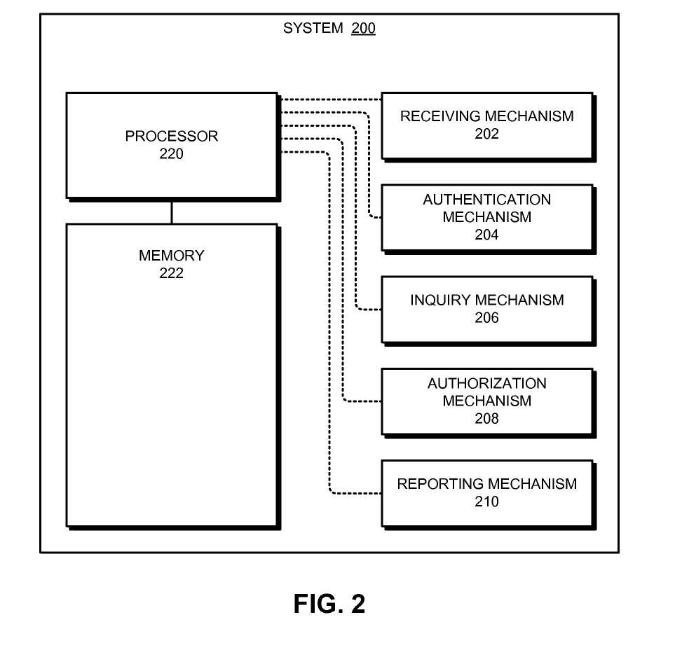

FIG. 2 illustrates a system 200 in accordance with an embodiment of the present invention. As illustrated in FIG. 2, system 200 can comprise server 150, database 170, appliance 190, client 110, devices 180, or any combination thereof. System 200 can also include receiving mechanism 202, authentication mechanism 204, inquiry mechanism 206, authorization mechanism 208, reporting mechanism 210, processor 220, and memory 222.

### Performing a Voice-Based Credit Card Transaction

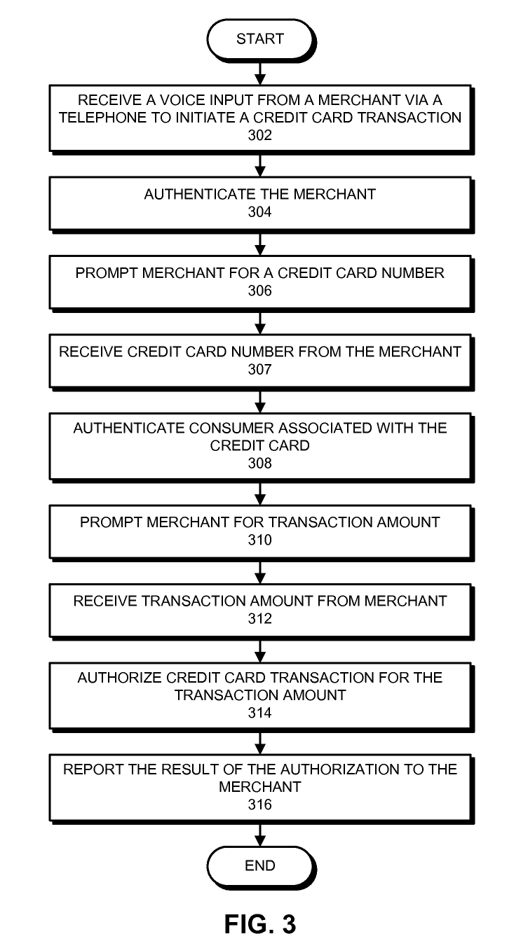

FIG. 3 presents a flow chart illustrating the process of performing a voice-based credit card transaction in accordance with an embodiment of the present invention. During operation, receiving mechanism 202 receives voice input from merchant 120 via a telephone (devices 180) to initiate a credit card transaction (operation 302). Next, authentication mechanism 204 authenticates merchant 120 (operation 304). Inquiry mechanism 206 then prompts merchant 120 for a credit card number (operation 306) and receives the credit card number from merchant 120 (operation 307). Next, authentication mechanism 204 authenticates a consumer associated with the credit card, consumer 122 (operation 308).

If authentication is successful, inquiry mechanism 206 prompts merchant 120 for a transaction amount (operation 310). Next, receiving mechanism 202 receives the transaction amount from merchant 120 (operation 312). Authorization mechanism 208 then authorizes the credit card transaction for the transaction amount (operation 314). Finally, reporting mechanism 210 reports the result of the authorization to merchant 120 (operation 316).

Note that as described previously, embodiments of the present invention are not meant to be limited to processing voice-based credit card transactions in this order. Some of the previously mentioned steps can occur in a different sequence, or can be combined into fewer operations.

### Voice-Based Credit Card Transaction Processing System

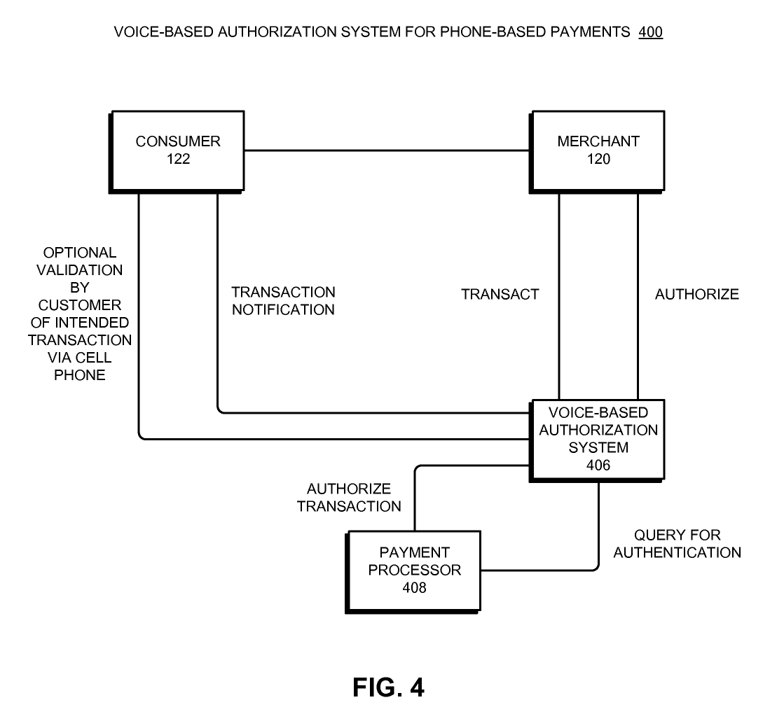

FIG. 4 presents a process flow diagram illustrating a voice-based authorization system for phone-based payments 400 in accordance with an embodiment of the present invention. Voice-based authorization system for phone-based payments 400 is comprised of merchant 120, consumer 122, voice-based authorization system 406, and payment processor 408. Note that voice-based authorization system 406 and payment processor 408 can comprise system 200, or can be two separate systems.

In a typical process flow, consumer 122 approaches merchant 120 to purchase some goods or services. Once a sale amount has been agreed upon, consumer 122 gives a credit card to merchant 120 as a form of payment. Next, merchant 120 calls a number for the voice-based authorization system 406 to process the payment. Note that merchant 120 places the call on a standard telephone or cell phone. No specialized equipment is required of merchant 120 to process the voice-based credit card transactions.

Upon receiving the incoming call from merchant 120, voice-based authorization system 406 validates the incoming call by using the caller ID and performs a lookup on database 170 to determine the identity of merchant 120. Note that this is the first form of authentication for merchant 120.

Next, voice-based authorization system 406 prompts merchant 120 for the merchant ID and verifies that it matches the ID for the phone number of the incoming call. Note that this is the second form of authentication for merchant 120. Finally, voice-based authorization system 406 prompts merchant 120 for a unique password associated with merchant 120. Upon determining the validity of the password, voice-based authorization system 406 successfully authenticates merchant 120.

Validating the merchant password comprises a third form of authentication for merchant 120. Furthermore, the merchant ID, the merchant password, or a combination of the two, can also indicate the specific salesperson for merchant 120 that is performing the transaction.

Once merchant 120 has been authenticated, voice-based authorization system 406 prompts merchant 120 to enter the credit card number for consumer 122. Note that merchant 120 may use the telephone keypad or speak the numerals into the phone. Once voice-based authorization system 406 receives the credit card number, voice-based authorization system 406 performs a lookup in database 170 to determine the name associated with the credit card. Voice-based authorization system 406 then asks merchant 120 to verify the name of consumer 122 by pressing “1” on the keypad of the phone, or by saying “yes” into the phone. Note that this comprises the first factor of consumer authentication.

Once consumer 122 has been identified by name, voice-based authorization system 406 prompts merchant 120 to enter the security code and expiration date of the credit card, thus providing the second factor of consumer authentication. Finally, voice-based authorization system 406 prompts consumer 122 for a pre-registered piece of information, such as a driver's license number. Note that merchant 120 can key in this information, speak it into the phone, or hand the phone to consumer 122 to provide the information. Furthermore, in some embodiments, consumer 122 may speak some information into the phone, such as their name, password, or a security phrase, and voice-based authorization system 406 performs a voice recognition or a voiceprint matching operation to authenticate consumer 122. Note that this comprises the third factor of consumer authentication.

Upon authenticating merchant 120 and consumer 122, voice-based authorization system 406 prompts merchant 120 to enter the transaction amount. Optionally, voice-based authorization system 406 can send an SMS authorization request or voice authorization request to consumer 122 at a pre-registered cell phone number to approve the transaction, thus providing an additional layer of security. Upon receiving confirmation from consumer 122, voice-based authorization system 406 processes the transaction.

Note that at this point, voice-based authorization system 406 can process the transaction, or can hand off the transaction processing to payment processor 408. Finally, voice-based authorization system 406 provides the transaction details to merchant 120. Optionally, voice-based authorization system 406 can also email a receipt to consumer 122 at a pre-registered email address, or can even send the receipt via SMS.

Note that, in some embodiments of the present invention, voice-based authorization system 406 may also leverage other information from the phone that merchant 120 uses to process the transaction. For example, if merchant 120's phone is a GPS-enabled cell phone, voice-based authorization system 406 may utilize the GPS information to determine the locale of the transaction and apply the appropriate state, county, and local sales taxes.

Most payment processors reduce their transaction fees if merchants provide more information and security. Credit card fraud is an extremely expensive problem for these processors. Note that as more information is received by the processor and more authentication is performed, the risk of fraud to the payment processor decreases, and in turn, they lower their transaction fees. Thus, embodiments of the present invention not only provide credit card transaction processing to merchants in emerging markets with no equipment or infrastructure needed, but they also do so at reduced cost to the merchant.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for performing voice-based credit card processing, the method comprising:
receiving voice input from a merchant at a computer via a telephone to initiate a credit card transaction;
authenticating the merchant;
prompting the merchant for a credit card number;
authenticating a consumer associated with the credit card;
prompting the merchant for a transaction amount;
receiving the transaction amount from the merchant;
authorizing the credit card transaction for the transaction amount; and
reporting the result of the authorization to the merchant.

2. The computer-implemented method of claim 1, wherein authenticating the merchant involves:
prompting the merchant for a merchant-authentication credential;
receiving the merchant-authentication credential from the merchant; and
authenticating the merchant with the merchant-authentication credential.

3. The computer-implemented method of claim 2, wherein the merchant-authentication credential can include at least one of:
a numeric string comprising dual-tone multi-frequency (DTMF) sounds;
a numeric string comprising spoken numerals; and
a verbal string comprising spoken words.

4. The computer-implemented method of claim 1, wherein authenticating the consumer associated with the credit card involves:
prompting the merchant for a consumer-authentication credential for the consumer associated with the credit card;
receiving the consumer-authentication credential from the merchant; and
authenticating the consumer with the consumer-authentication credential.

5. The computer-implemented method of claim 4, wherein the consumer-authentication credential includes at least one of:
an expiration date of the credit card;
a billing address of the credit card;
a security code of the credit card;
a driver's license number of the consumer;
a Social Security number of the consumer; and
a token pre-registered by the consumer.

6. The computer-implemented method of claim 1, wherein authenticating the merchant additionally involves:
looking up a merchant password associated with the merchant-authentication credential;
prompting the merchant for the merchant password;
receiving the merchant password from the merchant; and
determining if the merchant password received from the merchant matches the stored merchant password.

7. The computer-implemented method of claim 1, wherein authenticating the merchant additionally involves:
determining an origin telephone number for a telephone originating the voice input;
retrieving a list of authorized telephone numbers associated with the merchant; and
determining if the origin telephone number is a member of the list of authorized telephone numbers.

8. The computer-implemented method of claim 1, wherein authenticating the consumer additionally involves:
looking up a name associated with the credit card;
presenting the name to the merchant; and
receiving confirmation from the merchant that the name is correct.

9. The computer-implemented method of claim 1, wherein authorizing the credit card transaction involves:
sending a Short Message Service (SMS) message to the consumer; and
receiving an SMS response from the consumer.

10. The computer-implemented method of claim 1, wherein authorizing the credit card transaction involves:
placing an automated phone call to the consumer;
prompting the consumer to authorize the transaction;
receiving an acknowledgement from the consumer.

11. A computer-readable storage medium storing instructions that when executed by a computer cause the computer to perform a method for performing voice-based credit card processing, the method comprising:
receiving voice input from a merchant at a computer via a telephone to initiate a credit card transaction;
authenticating the merchant;
prompting the merchant for a credit card number;
authenticating a consumer associated with the credit card;
prompting the merchant for a transaction amount;
receiving the transaction amount from the merchant;
authorizing the credit card transaction for the transaction amount; and
reporting the result of the authorization to the merchant.

12. The computer-readable storage medium of claim 11, wherein authenticating the merchant involves:
prompting the merchant for a merchant-authentication credential;
receiving the merchant-authentication credential from the merchant; and
authenticating the merchant with the merchant-authentication credential.

13. The computer-readable storage medium of claim 12, wherein the merchant-authentication credential can include at least one of:
a numeric string comprising dual-tone multi-frequency (DTMF) sounds;
a numeric string comprising spoken numerals; and
a verbal string comprising spoken words.

14. The computer-readable storage medium of claim 11, wherein authenticating the consumer associated with the credit card involves:
prompting the merchant for a consumer-authentication credential for the consumer associated with the credit card;
receiving the consumer-authentication credential from the merchant; and
authenticating the consumer with the consumer-authentication credential.

15. The computer-readable storage medium of claim 14, wherein the consumer-authentication credential includes at least one of:
an expiration date of the credit card;
a billing address of the credit card;
a security code of the credit card;
a driver's license number of the consumer;
a Social Security number of the consumer; and
a token pre-registered by the consumer.

16. The computer-readable storage medium of claim 11, wherein authenticating the merchant additionally involves:
looking up a merchant password associated with the merchant-authentication credential;
prompting the merchant for the merchant password;
receiving the merchant password from the merchant; and
determining if the merchant password received from the merchant matches the stored merchant password.

17. The computer-readable storage medium of claim 11, wherein authenticating the merchant additionally involves:
determining an origin telephone number for a telephone originating the voice input;
retrieving a list of authorized telephone numbers associated with the merchant; and
determining if the origin telephone number is a member of the list of authorized telephone numbers.

18. The computer-readable storage medium of claim 11, wherein authenticating the consumer additionally involves:
looking up a name associated with the credit card;
presenting the name to the merchant; and
receiving confirmation from the merchant that the name is correct.

19. The computer-readable storage medium of claim 11, wherein authorizing the credit card transaction involves:
sending a Short Message Service (SMS) message to the consumer; and
receiving an SMS response from the consumer.

20. The computer-readable storage medium of claim 11, wherein authorizing the credit card transaction involves:
placing an automated phone call to the consumer;
prompting the consumer to authorize the transaction;
receiving an acknowledgement from the consumer.

21. An apparatus configured for performing voice-based credit card processing, comprising:
a processor;
a memory;
a receiving mechanism configured to receive voice input from a merchant via a telephone to initiate a credit card transaction;
an authentication mechanism configured to authenticate the merchant;
an inquiry mechanism configured to prompt the merchant for a credit card number;
wherein the authentication mechanism is further configured to authenticate a consumer associated with the credit card;
wherein the inquiry mechanism is further configured to prompt the merchant for a transaction amount;
wherein the receiving mechanism is further configured to receive the transaction amount from the merchant;
an authorization mechanism configured to authorize the credit card transaction for the transaction amount; and
a reporting mechanism configured to report the result of the authorization to the merchant.

22. The apparatus of claim 21, wherein the authentication mechanism authenticates the merchant by:
prompting the merchant for a merchant-authentication credential;
receiving the merchant-authentication credential from the merchant; and
authenticating the merchant with the merchant-authentication credential.

23. The computer-implemented method of claim 21, wherein the authentication mechanism authenticates the consumer by:
prompting the merchant for a consumer-authentication credential for the consumer associated with the credit card;
receiving the consumer-authentication credential from the merchant; and
authenticating the consumer with the consumer-authentication credential.
